(19) United States
(12) Patent Application Publication
(10) Pub. No.: US 2022/0128364 A1
(43) Pub. Date: Apr. 28, 2022

(54) NAVIGATION GUIDANCE

(71) Applicant: International Business Machines Corporation, Armonk, NY (US)

(72) Inventors: Meenal Kapoor, New Delhi (IN); Vinayak Sastri, BANGALORE (IN); Seema Nagar, Bangalore (IN); Kuntal Dey, Rampurhat (IN)

(21) Appl. No.: 17/080,989

(22) Filed: Oct. 27, 2020

(51) Int. Cl. G01C 21/20; B64C 39/02; G08G 5/00; G05D 1/10; G06N 20/00

(52) U.S. Cl. CPC G01C 21/20; B64C 39/02; G08G 5/0039; G06F 40/40; G05D 1/106; G06N 20/00; G08G 5/0043

(57) ABSTRACT

A current location of a plurality of aerial vehicles is determined. A destination for each aerial vehicle in the plurality of aerial vehicles is received. A route from the current location to the received destination for each aerial vehicle in the plurality of aerial vehicles is calculated. The calculated route is a straight-line between the current location and the received destination. A determination is made whether one or more impediments are identified in the calculated straight-line route of each aerial vehicle in the plurality of aerial vehicles. In response to determining that one or more impediments are identified in the calculated straight-line route for an aerial vehicle in the plurality of aerial vehicles, the route for the aerial vehicle based on a contextual permission of the aerial vehicle is re-calculated.

### BACKGROUND

The present invention relates generally to the field of navigation guidance, and more particularly to providing navigation guidance for perimeter-based object avoidance.

Using the Global Positioning System, or GPS, to determine a route from a starting point to an ending point is common. GPS is available on stand-alone units from any number of manufacturers. Many automobiles include some sort of navigation system displayed on a screen for drivers. Smartphones include a GPS application (i.e., “app”) for increased mobility. Smartwatches are also able to utilize a GPS app. Finding a quick route to where you need to go is easier than ever.

### SUMMARY OF THE INVENTION

Embodiments of the present invention include an approach for providing navigation guidance for aerial vehicles. In one embodiment, a current location of a plurality of aerial vehicles is determined. A destination for each aerial vehicle in the plurality of aerial vehicles is received. A route from the current location to the received destination for each aerial vehicle in the plurality of aerial vehicles is calculated. The calculated route is a straight-line between the current location and the received destination. A determination is made whether one or more impediments are identified in the calculated straight-line route of each aerial vehicle in the plurality of aerial vehicles. In response to determining that one or more impediments are identified in the calculated straight-line route for an aerial vehicle in the plurality of aerial vehicles, the route for the aerial vehicle based on a contextual permission of the aerial vehicle is re-calculated.

### BRIEF DESCRIPTION OF THE DRAWINGS

FIG. 1 depicts a functional block diagram of a computing environment, in accordance with an embodiment of the present invention;

FIG. 2 depicts a flowchart of a program for providing navigation guidance for aerial vehicles, in accordance with an embodiment of the present invention; and

FIG. 3 depicts a block diagram of components of the computing environment of FIG. 1, in accordance with an embodiment of the present invention.

### DETAILED DESCRIPTION

Embodiments of the present invention recognize that air traffic is becoming more complex and competition for air space is increasing. Conventional air traffic control systems coordinate flights from existing planes, jets, and helicopters. Air traffic from drones is increasing rapidly, from private drone owners as well as commercial drone owners for services such as delivery and photography. A new consumer of air space, that is aerial vehicles, will be taking flight sometime in the future. A system is needed for these aerial vehicles to safely fly in the crowded air space.

Embodiments of the present invention recognize that there may be a method, computer program product, and computer system for providing navigation guidance for aerial vehicles. In an embodiment, the method, computer program product, and computer system utilize the capabilities of the Global Positioning System (GPS) to plan a route from a starting point to an ending point. Impediments along the planned route are identified and the route is re-calculated as needed. The route is transmitted to the aerial vehicle and the progress of the aerial vehicle along the routed is monitored. As the aerial vehicle nears the ending point (i.e., the destination), a safe area for landing is identified and transmitted to the aerial vehicle.

References in the specification to “one embodiment”, “an embodiment”, “an example embodiment”, etc., indicate that the embodiment described may include a particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The present invention will now be described in detail with reference to the Figures.

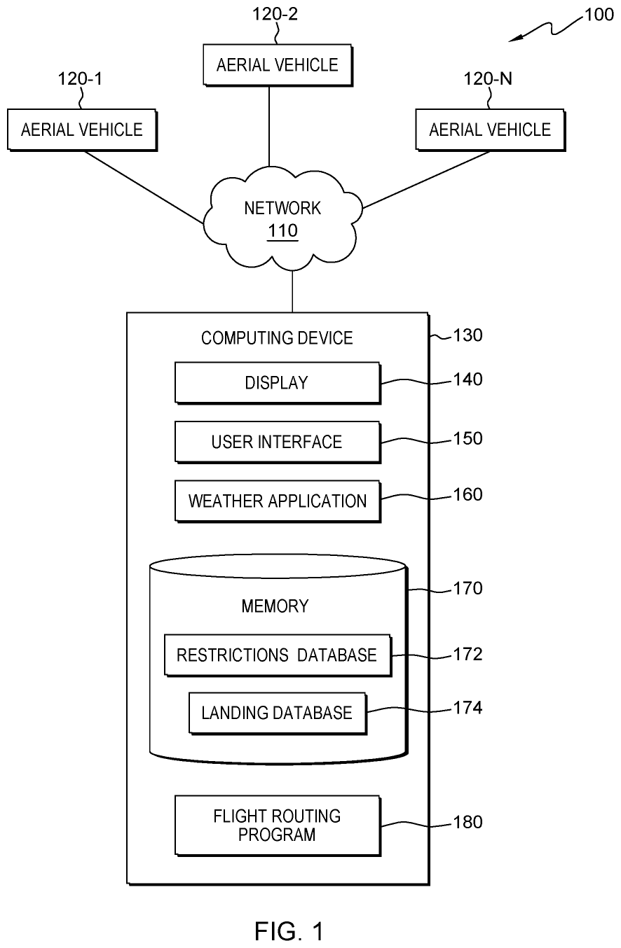

FIG. 1 is a functional block diagram illustrating a computing environment, generally designated 100, in accordance with one embodiment of the present invention. FIG. 1 provides only an illustration of one implementation and does not imply any limitations with regard to the systems and environments in which different embodiments may be implemented. Many modifications to the depicted embodiment may be made by those skilled in the art without departing from the scope of the invention as recited by the claims.

In an embodiment, computing environment 100 includes aerial vehicle 120-1, aerial vehicle 120-2, aerial vehicle 120-N, and computing device 130, interconnected by network 110. In example embodiments, computing environment 100 includes other computing devices (not shown in FIG. 1) such as smartwatches, cell phones, additional smartphones, wearable technology, phablets, tablet computers, additional laptop computers, additional desktop computers, other computer servers or any other computer system known in the art, interconnected with aerial vehicle 120-1, aerial vehicle 120-2, aerial vehicle 120-N, and computing device 130 over network 110. For ease of reading, the term aerial vehicle 120-N will be used when discussing features of any of aerial vehicle 120-1, aerial vehicle 120-2, and aerial vehicle 120-N.

In embodiments of the present invention, aerial vehicle 120-N and computing device 130 are connected to network 110, which enables aerial vehicle 120-N and computing device 130 to access other computing devices and/or data not directly stored on aerial vehicle 120-N and computing device 130. Network 110 may be, for example, a short-range, low power wireless connection, a local area network (LAN), a telecommunications network, a wide area network (WAN) such as the Internet, or any combination of the three, and include wired, wireless, or fiber optic connections. In an embodiment, network 110 includes one or more wired and/or wireless networks that are capable of receiving and transmitting data, voice, and/or video signals, including multimedia signals that include voice, data, and video information. In general, network 110 is any combination of connections and protocols that will support communications between aerial vehicle 120-N and computing device 130, and any other computing devices (not shown in FIG. 1) connected to network 110, in accordance with embodiments of the present invention. In an embodiment, data received by another computing device (not shown in FIG. 1) in computing environment 100 is communicated to aerial vehicle 120-N and computing device 130 via network 110.

According to embodiments of the present invention, aerial vehicle 120-N is a manually operated, semi-autonomous, or fully autonomous vehicle for carrying humans that is capable of flight (including takeoff and landing), as well as conventional driving on land. While not currently available to the public, experts in the aviation and automobile fields believe that aerial vehicles will one day be available for consumer use. Technologies that may be used for lift of aerial vehicle 120-N include, but are not limited to propellers with folding wings, rotorcraft with folding propeller blades, and tiltrotors. Aerial vehicle 120-N may include one or more computing devices that are substantially similar to computing device 130 (described below). Additionally, aerial vehicle 120-N may include computing devices with artificial intelligence and machine learning, one or more cameras and sensors, radio detection and ranging (radar), light detection and ranging (lidar), and any other systems and technologies known in the art that enable flight.

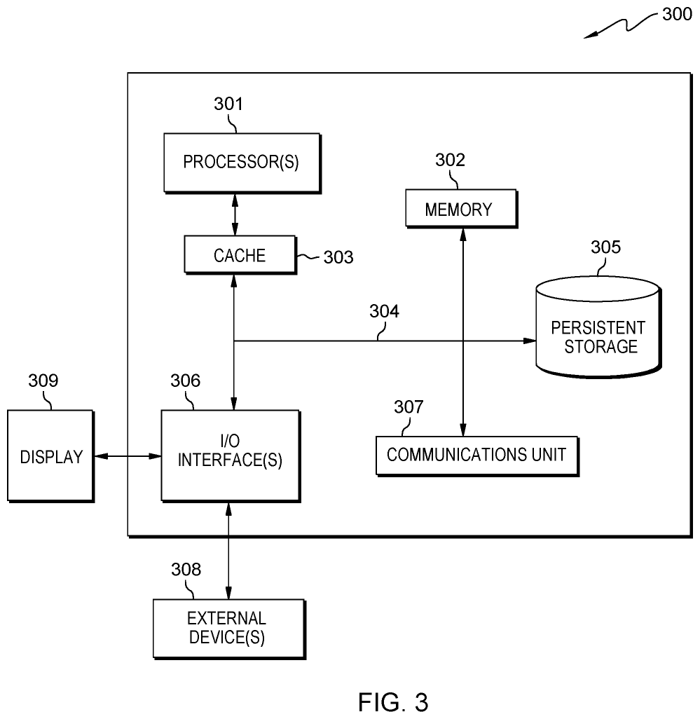

In embodiments of the present invention, computing device 130 may be one of a laptop, tablet, or netbook personal computer (PC), a desktop computer, a personal digital assistant (PDA), a smartphone, a standard cell phone, a smartwatch or any other wearable technology, or any other hand-held, programmable electronic device capable of communicating with any other computing device within computing environment 100. According to embodiments, computing device 130 can be a standalone computing device, a management server, a web server, a mobile computing device, or any other electronic device or computing system capable of receiving, transmitting, and processing data. In other embodiments, computing device 130 can represent computing systems utilizing multiple computers as a server system, such as in a cloud computing environment. In certain embodiments, computing device 130 represents a computer system utilizing clustered computers and components (e.g., database server computers, application server computers, etc.) that act as a single pool of seamless resources when accessed by elements of computing environment 100. In general, computing device 130 is representative of any electronic device or combination of electronic devices capable of executing computer readable program instructions. In an embodiment, computing environment 100 includes any number of computing device 130. Computing device 130 may include internal and external hardware components as depicted and described in further detail with respect to FIG. 3, in accordance with embodiments of the present invention. Computing device 130 may also include display 140, user interface (UI) 150, weather application 160, memory 170, and flight routing program 180.

According to an embodiment of the present invention, display 140 is an electronic visual device for a desktop computer, laptop computer, tablet computer, smartphone, smart-watch, and the like. Display 140 may include a touchscreen which is an input device layered on top of the display for allowing a user to control an electronic device via simple or multi-touch gestures by touching display 140 with a special stylus and/or one or more fingers. Display 140 displays user interface 150 as well as open programs and applications, allowing a user of computing device 130 to interact with the open programs and applications via a keyboard and mouse (not shown in FIG. 1) or via any other input technologies known in the art. Display 140 may be a thin film transistor liquid crystal display (TFT-LCD), a flat panel LED (light emitting diode) display, or a cathode ray tube (CRT). Display 140 may be connected to computing device 130 via VGA (video graphics array), DVI (digital video interface), HDMI (High Definition Multi-Media Interface or any other connection type known in the art.

In an embodiment, user interface 150 provides an interface between a user aerial vehicle 120-N, computing device 130, and flight routing program 180. User interface 150 may be a graphical user interface (GUI) or a web user interface (WUI) and can display text, documents, web browser windows, user options, application interfaces, and instructions for operation, and include the information (such as graphic, text, and sound) that a program presents to a user and the control sequences the user employs to control the program. User interface 150 may also be mobile application software that provides an interface between a user aerial vehicle 120-N, computing device 130, and flight routing program 180. Mobile application software, or an “app,” is a computer program designed to run on smartphones, tablet computers and other mobile devices. User interface 150 enables a user of computing device 130 to interact with aerial vehicle 120-N, flight routing program 180, and other computing devices not shown in FIG. 1.

According to an embodiment of the present invention, weather application 160 is an application, or app, for determining the current weather, and the forecasted weather, for a plurality of user-specified locations. In an embodiment, weather application 160 will provide weather information “on-demand” (i.e., when requested by a user). In another embodiment, weather application 160 will provide weather information on a user-defined periodic basis (e.g., every fifteen minutes, hourly, etc.). In yet another embodiment, weather application 160 will dynamically provide weather information when previously provided weather information changes. According to an embodiment of the present invention, information provided by weather application 160 is displayed by user interface 150 via display 140 on computing device 130.

In an embodiment, memory 170 is storage that is written to and/or read by flight routing program 180, and any other programs and applications on aerial vehicle 120-N and computing device 130. In one embodiment, memory 170 resides on computing device 130. In other embodiments, memory 170 resides on aerial vehicle 120-N, on any other device (not shown) in computing environment 100, in cloud storage, or on another computing device accessible via network 110. In yet another embodiment, memory 170 represents multiple storage devices within computing device 130. Memory 170 may be implemented using any volatile or non-volatile storage media for storing information, as known in the art. For example, memory 170 may be implemented with a tape library, optical library, one or more independent hard disk drives, multiple hard disk drives in a redundant array of independent disks (RAID), solid-state drives (SSD), or random-access memory (RAM). Similarly, memory 170 may be implemented with any suitable storage architecture known in the art, such as a relational database, an object-oriented database, or one or more tables. In an embodiment of the present invention, weather application 160, flight routing program 180, and any other programs and applications (not shown in FIG. 1) operating on computing device 130 may store, read, modify, or write data to memory 170. In an embodiment of the present invention, data stored to memory 170 includes, but is not limited to, data stored to restrictions database 172 and landing database 174.

According to embodiments of the present invention, restrictions database 172 is a memory location within memory 170 where specific information concerning flight restrictions for aerial vehicle 120-N are stored. In an embodiment, flight restrictions include, but are not limited to, densely populated air traffic routes, established no-fly zones (i.e., a territory or an area over which aircraft, including aerial vehicles, are not permitted to fly); dynamic no-fly zones (i.e., an area that cannot be flown over at a specific time or on a specific date); geographical features such as a mountain range or a large body of water; man-made features such as a skyscraper; known natural disasters (e.g., active wildfires, flooding, tornadoes, etc.); and anything else that may impede flight. According to an embodiment, the flight restrictions are permanent (e.g., a no-fly zone over the White House). According to another embodiment, the flight restrictions are temporary (e.g., a day long no-fly zone over a sports stadium hosting a major event).

In an embodiment, landing database 174 is a memory location within memory 170 where landing locations for use by flight routing program 180 are stored. In an embodiment, the locations stored to landing database 174 are legal landing locations available for routine use. In another embodiment, the locations stored to landing database 174 are not legal landing locations but are acceptable landing locations for use by aerial vehicle 120-N in an emergency. According to an embodiment, flight routing program 180 may identify, based on a received destination of aerial vehicle 120-N, one or more landing locations for aerial vehicle 120-N by searching landing database 174 for both legal and acceptable landing locations.

According to an embodiment of the present invention, flight routing program 180 can be a program, a subprogram of a larger program, an application, a plurality of applications, or mobile application software, which functions to provide navigation guidance for aerial vehicles. A program is a sequence of instructions written by a programmer to perform a specific task. In an embodiment, flight routing program 180 runs by itself. In other embodiments, flight routing program 180 depends on system software (not shown in FIG. 1) to execute. In one embodiment, flight routing program 180 functions as a stand-alone program residing on computing device 130. In another embodiment, flight routing program 180 works in conjunction with other programs, applications, etc., found in computing environment 100. In yet another embodiment, flight routing program 180 resides on aerial vehicle 120-N. In yet another embodiment, flight routing program 180 resides on other computing devices (not shown in FIG. 1) in computing environment 100, which are interconnected to aerial vehicle 120-N and computing device 130 via network 110.

In an embodiment, flight routing program 180 determines a current location. In the embodiment, based on a received destination, flight routing program 180 calculates a straight-line route to the destination and transmits the route to aerial vehicle 120-N. Further in the embodiment, if one or more impediments that would negatively impact the calculated route are identified, flight routing program 180 re-calculates the route to avoid the one or more identified impediments. Further yet in the embodiment, flight routing program 180 adjusts the route as needed, identifies a landing location, and transmits the landing location to aerial vehicle 120-N prior to landing.

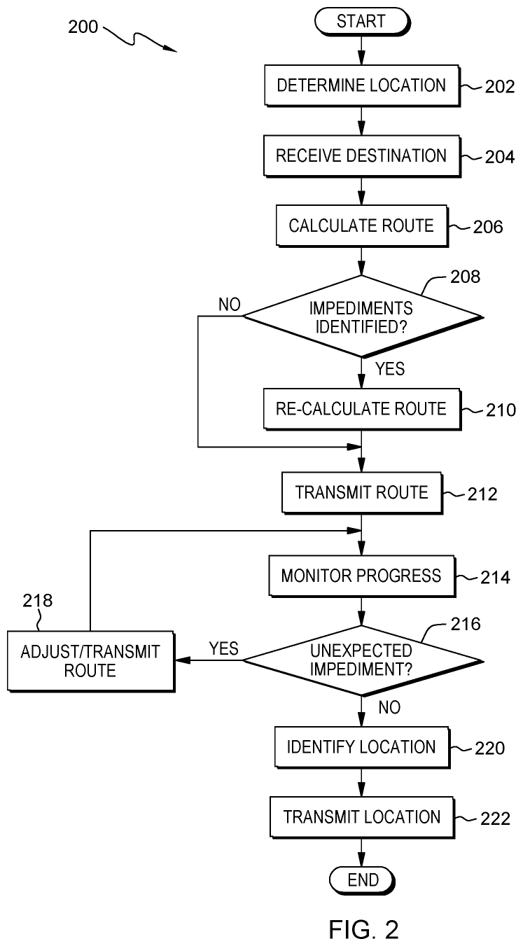

FIG. 2 is a flowchart of workflow 200 depicting a method for providing navigation guidance for aerial vehicles. In one embodiment, the method of workflow 200 is performed by flight routing program 180. In an alternative embodiment, the method of workflow 200 is performed by any other program working with flight routing program 180. In an embodiment, a user, via user interface 150, invokes workflow 200 upon identifying a destination for travel. In an alternative embodiment, a user invokes workflow 200 upon accessing flight routing program 180 on computing device 130 via network 110.

In an embodiment, flight routing program 180 determines location (step 202). In other words, flight routing program 180 determines a current location of aerial vehicle 120-N. According to an embodiment of the present invention, flight routing program 180 determines the current location based on a set of Global Positioning System (GPS) coordinates. In the embodiment, flight routing program 180 utilizes GPS technology (not shown in FIG. 1) included in computing device 130 to determine the current location of aerial vehicle 120-N. In another embodiment, flight routing program 180 determines the current location based on an input from a user of computing device 130. In the embodiment, the user may enter the current location via user interface 150 included on computing device 130. In an embodiment, flight routing program 180 determines the current location of aerial vehicle 120-N via the GPS included on computing device 130. For example, Bob inputs a current location of Tri-Cities Airport, Endicott, N.Y. via the user interface on smartphone.

According to an embodiment of the present invention, flight routing program 180 receives destination (step 204). In other words, flight routing program 180 receives a trip destination for aerial vehicle 120-N. In an embodiment, flight routing program 180 receives the destination from a user of computing device 130 via an included user interface. According to an embodiment, the received destination is exact (e.g., a set of GPS coordinates or an established airport). According to another embodiment, the received destination is approximate (e.g., a zip code, city name, or a recognized location such as Isle Royale National Park). In an embodiment, flight routing program 180 receives a destination for aerial vehicle 120-N from an input of a user of computing device 130 via user interface 150. For example, Bob inputs, via the smartphone, the trip destination of Hershey Park, Pa.

In an embodiment, flight routing program 180 calculates route (step 206). In other words, flight routing program 180 calculates a straight-line route between the determined current location and the received destination. According to an embodiment of the present invention, flight routing program 180 uses GPS to calculate the straight-line route between the two locations. According to another embodiment of the present invention, flight routing program 180 uses any mapping technology known in the art to calculate the straight-line route between the two points. In an embodiment, flight routing program 180 utilizes GPS included on computing device 130 (not shown in FIG. 1) to calculate a straight-line route between the determined current location of aerial vehicle 120-N and the received destination of aerial vehicle 120-N. For example, a program on the smartphone used by Bob calculates a straight-line route between Tri-Cities Airport in Endicott, N.Y. and Hershey Park, Pa.

According to an embodiment of the present invention, flight routing program 180 determines whether flight impediments are identified (decision step 208). In other words, responsive to calculating the straight-line route between the current location and the received destination, flight routing program 180 determines whether there are any flight impediments along the calculated straight-line route. In an embodiment, flight impediments are anything that mandates a re-calculating of the previously calculated straight-line route. In the embodiment, flight impediments include, but are not limited to, densely populated air traffic routes, established no-fly zones (i.e., a territory or an area over which aircraft, including aerial vehicles, are not permitted to fly); dynamic no-fly zones (i.e., an area that cannot be flown over at a specific time or on a specific date); geographical features such as a mountain range or a large body of water; man-made features such as a skyscraper; known natural disasters (e.g., active wildfires, flooding, tornadoes, etc.); and anything else that may impede flight. According to an embodiment of the present invention, flight routing program 180 identifies impediments along the calculated straight-line route by searching restrictions database 172 which is a collection of flight restrictions. In one embodiment (decision step 208, YES branch), flight routing program 180 determines that one or more flight impediments have been identified; therefore, flight routing program 180 proceeds to step 210 to re-calculate the route. In the embodiment (decision step 208, NO branch), flight routing program 180 determines that no flight impediments have been identified; therefore, flight routing program 180 proceeds to step 212 to transmit the route.

In an embodiment, flight routing program 180 re-calculates route (step 210). In other words, responsive to determining that one or more flight impediments have been identified along the calculated straight-line route, flight routing program 180 re-calculates the flight route to avoid the identified flight impediments. According to an embodiment of the present invention, flight routing program 180 uses any mapping technology known in the art to re-calculate the route to avoid the identified flight impediments. In an embodiment, flight routing program 180 utilizes GPS included on computing device 130 (not shown in FIG. 1) to re-calculate the route between the determined current location of aerial vehicle 120-N and the received destination of aerial vehicle 120-N to avoid the identified flight impediments. For example, the program on the smartphone used by Bob re-calculates the route between Tri-Cities Airport in Endicott, N.Y. and Hershey Park, Pa. to avoid an established no-fly zone.

According to an embodiment of the present invention, flight routing program 180 incorporates the contextual permission of the aerial vehicle when re-calculating the flight route. According to the embodiment, the contextual permission is the permission level of the aerial vehicle. Further, according to the embodiment, the permission level of the aerial vehicle defines a set of parameters for where and when the aerial vehicle is permitted to fly. In an embodiment, the contextual permission of the aerial vehicle is pre-determined by an authority and is based on trust (i.e., the owner of the aerial vehicle registers the aerial vehicle with the authority and provides the authority with a flight plan and a passenger manifest). The authority the determines a permission level for the aerial vehicle based on the provided information from the owner of the aerial vehicle. In another embodiment, the contextual permission of the vehicle is determined by a computing device utilizing some combination of Artificial Intelligence (AI) algorithms, Machine Learning (ML), and Natural Language Processing (NLP) of the information associated with the owner of the aerial vehicle. An aerial vehicle with a high permission level may be assigned a new flight route that allows the aerial vehicle to fly closer to the no-fly zone than an aerial vehicle with a low permission level.

According to an embodiment, AI is intelligence demonstrated by machines, in contrast to the natural intelligence displayed by humans. That is, any device that perceives its environment and takes actions that maximize its chance of successfully achieving its goals exhibits AI. Further, according to the embodiment, ML is a method of data analysis that automates analytical model building. ML is a branch of AI based on the idea that systems can learn from data, identify patterns and make decisions with minimal human intervention. Further yet, according to the embodiment, NLP is a subfield of linguistics, computer science, information engineering, and AI concerned with the interactions between computers and human (i.e., natural) languages, in particular how to program computers to process and analyze large amounts of natural language data.

In one embodiment, flight routing program 180 re-calculates the route by incorporating the contextual permission of the aerial vehicle and determining the shortest route between the determined current location and the received destination while considering the applicable rules and regulations of the no-fly zone. In a first example, the no-fly zone may have an altitude limitation such as any aircraft in flight must be at least five thousand feet above the no-fly zone region. In this first example, an aircraft, such as aerial vehicle 120-N, is required to fly at an altitude of at least five thousand feet but may fly directly over the no-fly zone. In a second example, the no-fly zone may have a horizontal limitation (without an altitude limitation) such as any aircraft in flight cannot fly within three nautical miles of the boundary of the no-fly zone. In this second example, an aircraft, such as aerial vehicle 120-N, is required only to remain at least three nautical miles away from the boundary of the no-fly zone; the aircraft may fly at any altitude.

In another embodiment, flight routing program 180 may incorporate the contextual permission of the aerial vehicle and determine a minimum threshold distance in a horizontal plane, in addition to the horizontal limitation discussed above, to remain a specified distance from the no-fly zone. In the embodiment, flight routing program 180 may apply the minimum threshold distance in a horizontal plane based on criteria such as current weather (e.g., poor weather may dictate an increased horizontal distance); sensitivity of the no-fly zone (e.g., a live fire range may dictate an increased horizontal distance); and operating times of the no-fly zone (e.g., the no-fly zone may be in effect on only Monday through Friday so an increased horizontal distance is applied during those days).

In yet another embodiment, multiple instances of flight routing program 180 may coordinate the positioning of one or more aerial vehicles based on the individual contextual permissions for each aerial vehicle while said aerial vehicles are in flight. For example, a first aerial vehicle flying ahead of a second aerial vehicle may be instructed to take a position behind the second aerial vehicle as both aerial vehicles approach a specific impediment based on the contextual permissions of the first and second aerial vehicles. In the example, the second aerial vehicle has a higher contextual permission than that of the first aerial vehicle. Further in the example, this repositioning occurs at a threshold distance from the specific impediment.

In yet another embodiment, the flight impediment may be a physical structure such as a mountain range or a tall building rather than a no-fly zone. In this embodiment, flight routing program 180 may apply the minimum threshold distance in the case of a skyscraper during the work week but may not apply the minimum threshold distance in the case of the skyscraper on the weekend. In both instances, flight routing program 180 considers the contextual permission level of the aerial vehicle. In the skyscraper example, this situation is dynamic; that is, the population of the skyscraper is variable based on the day of the week. Further in this embodiment, flight routing program 180 may not apply the minimum threshold distance in the case of a mountain range. In the mountain range example, this situation is static; that is, aspects concerning the mountain range are not variable. Thus, flight routing program 180 can incorporate multiple data points in determining whether a minimum threshold distance is required.

According to an embodiment of the present invention, flight routing program 180 transmits route (step 212). In other words, flight routing program 180 transmits, via an available, network either (i) the calculated route (when no flight impediments have been identified or (ii) the re-calculated route (when one or more flight impediments have been identified). In an embodiment, flight routing program 180 transmits the route directly to aerial vehicle 120-N. In another embodiment, flight routing program 180 transmits the route to display 140 on computing device 130. According to an embodiment of the present invention, flight routing program 180 transmits the calculated route, via network 110, from computing device 130 to aerial vehicle 120-N. For example, the program on the smartphone used by Bob transmits the calculated route to the display of the smartphone where Bob can view the calculated route.

In an embodiment, flight routing program 180 monitors progress (step 214). In other words, responsive to receiving the transmitted route for the trip from the determined current location to the received destination, flight routing program 180 monitors the progress of the trip being taken by an aerial vehicle. According to an embodiment of the present invention, flight routing program 180 monitors progress by comparing the calculated route variables (e.g., location, altitude, speed, direction, etc.) with the real-time values of those same route variables. In the embodiment, if a discrepancy between the calculated and real-time variables is identified, flight routing program 180 will notify (i) the aerial vehicle, (ii) the computing device (if available), and (iii) one or more passengers of the aerial vehicle. The discrepancy may be a threshold (e.g., “x” percent off the calculated variable, where “x” is determined by a user and is a value such as two, five, ten, etc.) or the discrepancy may be a specific value (e.g., one hundred feet off the calculated altitude, five degrees off the calculated route longitude or latitude, etc.). In an embodiment, flight routing program 180 monitors the trip progress of aerial vehicle 120-N. For example, the program on the smartphone used by Bob monitors the trip from Tri-Cities Airport, Endicott, N.Y. to Hershey Park, Pa.

According to an embodiment of the present invention, flight routing program 180 determines whether unexpected flight impediments are identified (decision step 216). In other words, flight routing program 180 determines whether an unexpected impediment (not included in restrictions database 172) is identified as the trip progresses from the determined current location to the received destination. In an embodiment, the unexpected impediment is identified in any manner; for example, visually by a passenger of the aerial vehicle or a camera included in the aerial vehicle or sensed by one or more sensors (radar, lidar, etc.) included in the aerial vehicle. According to one embodiment (decision step 216, YES branch), flight routing program 180 determines that an unexpected impediment is identified; therefore, flight routing program 180 proceeds to step 218 to adjust the route and transmit the adjusted route. According to the embodiment (decision step 216, NO branch), flight routing program 180 determines that no unexpected impediment was identified; therefore, flight routing program 180 proceeds to step 220 to identify a location.

In an embodiment, flight routing program 180 adjusts and transmits route (step 218). In other words, responsive to determining that an unexpected impediment is identified, flight routing program 180 adjusts the route and transmits the adjusted route to the aerial vehicle. According to an embodiment of the present invention, flight routing program 180 updates restrictions database 172 in memory 170 on computing device 130 with information related to the identified unexpected impediment. In an embodiment, flight routing program 180 adjusts the route utilizing GPS and other technologies known in the art to avoid the identified impediment. In the embodiment, flight routing program 180 transmits the adjusted route in the same manner as previously discussed. According to an embodiment of the present invention, flight routing program 180 adjusts the route to be flown by aerial vehicle 120-N utilizing GPS on aerial vehicle 120-N; further, flight routing program 180 transmits the adjusted route from computing device 130 to aerial vehicle 120-N via network 110. For example, an unexpected impediment of a convention of air ships (i.e., “blimps”) is identified by radar in the aerial vehicle carrying Bob. In the example, the program on the smartphone adjusts the route using GPS to travel safely around the blimp convention. Further, the adjusted route is transmitted to the aerial vehicle so that the aerial vehicle can adjust course to avoid the blimps.

According to an embodiment, flight routing program 180 identifies location (step 220). In other words, responsive to nearing the received destination, flight routing program 180 identifies one or more landing locations to be used by the aerial vehicle. In an embodiment, the landing location is a registered airport, airfield, airstrip, or any other legal landing location for aircraft. In another embodiment, the landing location is any safe location (e.g., a safe stretch of empty highway) where the aerial vehicle can land without causing harm to people or damage to property. According to embodiments of the present invention, flight routing program 180 identifies one or more landing locations near the received destination for use by aerial vehicle 120-N. For example, the program on the smartphone used by Bob identifies Harrisburg International Airport (MDT) which is approximately twelve minutes from Hershey Park, Pa.

In an embodiment, flight routing program 180 transmits location (step 222). In other words, responsive to identifying a landing location, flight routing program 180 transmits the identified location to the aerial vehicle via an available network. In an embodiment, flight routing program 180 transmits the identified location directly to aerial vehicle 120-N. In another embodiment, flight routing program 180 transmits the identified location to display 140 on computing device 130. According to an embodiment of the present invention, flight routing program 180 transmits the identified landing location, via network 110, from computing device 130 to aerial vehicle 120-N. For example, the program on the smartphone used by Bob transmits the identified landing location to the display of the smartphone where Bob can view the identified landing location.

FIG. 3 depicts computer system 300, which is an example of a system that includes flight routing program 180. Computer system 300 includes processors 301, cache 303, memory 302, persistent storage 305, communications unit 307, input/output (I/O) interface(s) 306 and communications fabric 304. Communications fabric 304 provides communications between cache 303, memory 302, persistent storage 305, communications unit 307, and input/output (I/O) interface(s) 306. Communications fabric 304 can be implemented with any architecture designed for passing data and/or control information between processors (such as microprocessors, communications and network processors, etc.), system memory, peripheral devices, and any other hardware components within a system. For example, communications fabric 304 can be implemented with one or more buses or a crossbar switch.

Memory 302 and persistent storage 305 are computer readable storage media. In this embodiment, memory 302 includes random access memory (RAM). In general, memory 302 can include any suitable volatile or non-volatile computer readable storage media. Cache 303 is a fast memory that enhances the performance of processors 301 by holding recently accessed data, and data near recently accessed data, from memory 302.

Program instructions and data used to practice embodiments of the present invention may be stored in persistent storage 305 and in memory 302 for execution by one or more of the respective processors 301 via cache 303. In an embodiment, persistent storage 305 includes a magnetic hard disk drive. Alternatively, or in addition to a magnetic hard disk drive, persistent storage 305 can include a solid-state hard drive, a semiconductor storage device, read-only memory (ROM), erasable programmable read-only memory (EPROM), flash memory, or any other computer readable storage media that is capable of storing program instructions or digital information.

The media used by persistent storage 305 may also be removable. For example, a removable hard drive may be used for persistent storage 305. Other examples include optical and magnetic disks, thumb drives, and smart cards that are inserted into a drive for transfer onto another computer readable storage medium that is also part of persistent storage 305.

Communications unit 307, in these examples, provides for communications with other data processing systems or devices. In these examples, communications unit 307 includes one or more network interface cards. Communications unit 307 may provide communications through the use of either or both physical and wireless communications links. Program instructions and data used to practice embodiments of the present invention may be downloaded to persistent storage 305 through communications unit 307.

I/O interface(s) 306 allows for input and output of data with other devices that may be connected to each computer system. For example, I/O interface 306 may provide a connection to external devices 308 such as a keyboard, keypad, a touch screen, and/or some other suitable input device. External devices 308 can also include portable computer readable storage media such as, for example, thumb drives, portable optical or magnetic disks, and memory cards. Software and data used to practice embodiments of the present invention can be stored on such portable computer readable storage media and can be loaded onto persistent storage 305 via I/O interface(s) 306. PO interface(s) 306 also connect to display 309.

Display 309 provides a mechanism to display data to a user and may be, for example, a computer monitor.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

What is claimed is:

1. A method, the method comprising:
determining, by one or more computer processors, a current location of a plurality of aerial vehicles;
receiving, by one or more computer processors, a destination for each aerial vehicle in the plurality of aerial vehicles;
calculating, by one or more computer processors, a route from the current location to the received destination for each aerial vehicle in the plurality of aerial vehicles, wherein in the calculated route is a straight-line between the current location and the received destination;
determining, by one or more computer processers, whether one or more impediments are identified in the calculated straight-line route of each aerial vehicle in the plurality of aerial vehicles; and
responsive to determining that one or more impediments are identified in the calculated straight-line route for an aerial vehicle in the plurality of aerial vehicles, re-calculating, by one or more computer processors, the route for the aerial vehicle based on a contextual permission of the aerial vehicle.

2. The method of claim 1, wherein:
the contextual permission is a permission level of the aerial vehicle; and
the permission level of the aerial vehicle defines a set or parameter for where and when the aerial vehicle is permitted to fly.

3. The method of claim 1, wherein a determination of the contextual permission of the aerial vehicle is selected from the group consisting of by an authority based on trust of a registered owner of the aerial vehicle and by a computing device utilizing a combination of artificial intelligence, machine learning, and natural language processing of information associated with the registered owner of the aerial vehicle.

4. The method of claim 1, further comprising:
transmitting, by one or more computer processors, one of the calculated straight-line route and the re-calculated route to the aerial vehicle;
monitoring, by one or more computer processors, a progress of the aerial vehicle along the transmitted route as the aerial vehicle proceeds to the received destination;
determining, by one or more computer processors, whether an unexpected impediment is identified while the aerial vehicle progresses along the transmitted route;
responsive to determining that an unexpected impediment was identified, re-calculating the transmitted route to avoid the unexpected impediment; and
transmitting, by one or more computer processors, the re-calculated transmitted route to the aerial vehicle.

5. The method of claim 1, further comprising:
identifying, by one or more computer processors, one or more locations where the aerial vehicle can safely land as the aerial vehicle nears the received destination; and
transmitting, by one or more computer processors, the identified one or more locations to the aerial vehicle.

6. The method of claim 4, wherein the re-calculated route avoids the one or more identified impediments.

7. The method of claim 4, wherein the one or more impediments are selected from the group consisting of a densely populated air traffic route, an established no-fly zone, a dynamic no-fly zone, one or more geographical features such as a mountain range or a large body of water, one or more man-made features such as a skyscraper, and a known natural disaster.

8. A computer program product, the computer program product comprising:
one or more computer readable storage media; and
program instructions stored on the one or more computer readable storage media, the program instructions comprising:
program instructions to determine a current location of a plurality of aerial vehicles;
program instructions to receive a destination for each aerial vehicle in the plurality of aerial vehicles;
program instructions to calculate a route from the current location to the received destination for each aerial vehicle in the plurality of aerial vehicles, wherein in the calculated route is a straight-line between the current location and the received destination;
program instructions to determine whether one or more impediments are identified in the calculated straight-line route of each aerial vehicle in the plurality of aerial vehicles; and
responsive to determining that one or more impediments are identified in the calculated straight-line route for an aerial vehicle in the plurality of aerial vehicles, program instructions to re-calculate the route for the aerial vehicle based on a contextual permission of the aerial vehicle.

9. The computer program product of claim 8, wherein:
the contextual permission is a permission level of the aerial vehicle; and
the permission level of the aerial vehicle defines a set or parameter for where and when the aerial vehicle is permitted to fly.

10. The computer program product of claim 8, wherein a determination of the contextual permission of the aerial vehicle is selected from the group consisting of by an authority based on trust of a registered owner of the aerial vehicle and by a computing device utilizing a combination of artificial intelligence, machine learning, and natural language processing of information associated with the registered owner of the aerial vehicle.

11. The computer program product of claim 8, further comprising program instructions stored on the one or more computer readable storage media, to:
transmit one of the calculated straight-line route and the re-calculated route to the aerial vehicle;
monitor a progress of the aerial vehicle along the transmitted route as the aerial vehicle proceeds to the received destination;
determine whether an unexpected impediment is identified while the aerial vehicle progresses along the transmitted route;
responsive to determining that an unexpected impediment was identified, re-calculate the transmitted route to avoid the unexpected impediment; and
transmit the re-calculated transmitted route to the aerial vehicle.

12. The computer program product of claim 8, further comprising program instructions stored on the one or more computer readable storage media, to:
identify one or more locations where the aerial vehicle can safely land as the aerial vehicle nears the received destination; and
transmit the identified one or more locations to the aerial vehicle.

13. The computer program product of claim 11, wherein the re-calculated route avoids the one or more identified impediments.

14. The computer program product of claim 11, wherein the one or more impediments are selected from the group consisting of a densely populated air traffic route, an established no-fly zone, a dynamic no-fly zone, one or more geographical features such as a mountain range or a large body of water, one or more man-made features such as a skyscraper, and a known natural disaster.

15. A computer system, the computer system comprising:
one or more computer processors;
one or more computer readable storage media; and
program instructions stored on the one or more computer readable storage media for execution by at least one of the one or more computer processors, the program instructions comprising:
program instructions to determine a current location of a plurality of aerial vehicles;
program instructions to receive a destination for each aerial vehicle in the plurality of aerial vehicles;
program instructions to calculate a route from the current location to the received destination for each aerial vehicle in the plurality of aerial vehicles, wherein in the calculated route is a straight-line between the current location and the received destination;
program instructions to determine whether one or more impediments are identified in the calculated straight-line route of each aerial vehicle in the plurality of aerial vehicles; and
responsive to determining that one or more impediments are identified in the calculated straight-line route for an aerial vehicle in the plurality of aerial vehicles, program instructions to re-calculate the route for the aerial vehicle based on a contextual permission of the aerial vehicle.

16. The computer system of claim 15, wherein:
the contextual permission is a permission level of the aerial vehicle; and
the permission level of the aerial vehicle defines a set or parameter for where and when the aerial vehicle is permitted to fly.

17. The computer system of claim 15, wherein a determination of the contextual permission of the aerial vehicle is selected from the group consisting of by an authority based on trust of a registered owner of the aerial vehicle and by a computing device utilizing a combination of artificial intelligence, machine learning, and natural language processing of information associated with the registered owner of the aerial vehicle.

18. The computer system of claim 15, further comprising program instructions stored on the one or more computer readable storage media for execution by at least one of the one or more computer processors, to:
transmit one of the calculated straight-line route and the re-calculated route to the aerial vehicle;
monitor a progress of the aerial vehicle along the transmitted route as the aerial vehicle proceeds to the received destination;
determine whether an unexpected impediment is identified while the aerial vehicle progresses along the transmitted route;
responsive to determining that an unexpected impediment was identified, re-calculate the transmitted route to avoid the unexpected impediment; and
transmit the re-calculated transmitted route to the aerial vehicle.

19. The computer system of claim 15, further comprising program instructions stored on the one or more computer readable storage media for execution by at least one of the one or more computer processors, to:
identify one or more locations where the aerial vehicle can safely land as the aerial vehicle nears the received destination; and
transmit the identified one or more locations to the aerial vehicle.

20. The computer system of claim 18, wherein the re-calculated route avoids the one or more identified impediments.
